(19) United States
(12) Patent Application Publication
(10) Pub. No.: US 2026/0162856 A1
(43) Pub. Date: Jun. 11, 2026

(54) GROMMET

(71) Applicant: YAZAKI CORPORATION, Tokyo (JP)

(72) Inventors: Hirotaka Kiyota, Makinohara-shi (JP); Takeshi Onoda, Makinohara-shi (JP); Toshinori Yamada, Makinohara-shi (JP)

(21) Appl. No.: 19/181,353

(22) Filed: Apr. 17, 2025

Related U.S. Application Data
(63) Continuation of application No. PCT/JP2024/001791, filed on Jan. 23, 2024.

(30) Foreign Application Priority Data
Feb. 27, 2023 (JP) 2023-027921

(51) Int. Cl. H01B 17/58

(52) U.S. Cl. CPC H01B 17/583

(57) ABSTRACT

A base member provided with a seal member is provided between joint surfaces of a plurality of divided base members radially divided around an axis of an insertion path, the base member is formed by combining divided pipes of each of the plurality of divided base members, and has a tubular body that draws out a wiring member of the inner insertion path from an opening, the tubular body has a bent portion and a straight pipe portion having an opening, the opening is closed by a waterproof tape wound between an outer peripheral surface of the straight pipe portion and the wiring member drawn out from the opening, and the straight pipe portion is provided with a tape position designation portion which designates an allowable range of an end portion position of the waterproof tape on the straight pipe portion side at a place.

### CROSS-REFERENCE TO RELATED APPLICATION

This application is a continuation application of International Application No. PCT/JP2024/001791 filed on January 23, 2024 which claims the benefit of priority from Japanese Patent Application No. 2023-027921 filed on February 27, 2023 and designating the U.S., the entire contents of which are incorporated herein by reference.

### BACKGROUND OF THE INVENTION

### 1. Field of the Invention

The present invention relates to a grommet.

### 2. Description of the Related Art

Conventionally, in a wire harness, a wiring member such as an electric wire is inserted into a through-hole provided in an insertion object (for example, a panel or the like of a vehicle body in a vehicle), and thus the wiring member is routed between one space and the other space separated by the insertion object. For this reason, in order to protect the wiring member from the peripheral edge of the through-hole and to prevent liquid from entering the gap between the through-hole and the wiring member, a grommet that closes the gap is attached to the insertion object. For example, the grommet includes a base member made of a hard synthetic resin material and an annular waterproof member made of a synthetic resin material having flexibility such as rubber, and is inserted into the through-hole to bring the waterproof member into close contact with the peripheral edge of the through-hole in the insertion object. The wiring member is routed between one space and the other space through the inside of the base member. The base member is provided with a tubular body through which the wiring member passes. Therefore, in the grommet, by forming the base member into a two-split structure of a first base member and a second base member, the arrangement work of the wiring member to the wiring path inside the base member is facilitated. In this grommet, the seal member is sandwiched between the joint surfaces of the first base member and the second base member, thereby preventing liquid from entering from the joint surfaces. For example, JP H08 – 251769 A below discloses a grommet configured as described above.

Incidentally, in this type of grommet, since the wiring member is drawn out from the opening of the tubular body, in order to close the gap between the opening and the wiring member, the waterproof tape is wound around the tubular body and the wiring member over the front and rear of the opening. However, in this grommet, when the waterproof tape is wound, the first base member and the second base member are already assembled by aligning and joining the joint surfaces of the first base member and the second base member, and thus it is difficult to confirm the position of the seal member provided on the joint surface from the appearance, and it is difficult to recognize the end portion position of the seal member between the joint surfaces in the tubular body. In this grommet, by covering up to the end portion position of the seal member with the waterproof tape, suitable waterproofness between the joint surfaces can be obtained, but it is difficult to determine whether or not the waterproof tape suitable for waterproofness is wound due to the difficulty in understanding the end portion position. In addition, in the grommet, for example, the destination of the wiring member drawn into one space from the through-hole of the insertion object can be directed based on the bending direction of the tubular body of the base member bent in one space. However, in this grommet, the tubular body is bent, and thus the position where the waterproof tape can be wound on the tubular body side is limited to the straight pipe part on the opening side. In addition, in this grommet, a space in which the winding operation of the waterproof tape can be performed is determined depending on the bending position or the shape of the tubular body such as the bending shape and the peripheral shape of the tubular body in the base member, and thus there is a possibility that the position where the waterproof tape can be wound in the straight pipe part is further limited. Therefore, in this grommet, the range of the position where the waterproof tape can be wound with respect to the axial length of the tubular body is narrow, and furthermore, the end portion position of the waterproof tape on the tubular body side needs to be restricted according to the end portion position of the seal member, and there is room for improvement in ensuring the waterproofness.

### SUMMARY OF THE INVENTION

Therefore, an object of the present invention is to provide a grommet that can ensure waterproofness.

In order to achieve the above mentioned object, a grommet according to one aspect of the present invention includes: a base member including a plurality of divided base members made of a synthetic resin material radially divided around an axis of an insertion path, in which a conductive wiring member passed through a through-hole of an insertion object between one space and the other space is inserted into the inner insertion path formed by aligning and joining joint surfaces of the plurality of divided base members facing each other; an annular grommet main body assembled to the base member and disposed in the one space at an attachment completion position of the insertion object to a peripheral edge portion of the through-hole; and a seal member sandwiched between the joint surfaces facing each other of the plurality of divided base members and filling a gap between the joint surfaces at a sandwiching position, wherein the base member includes an annular flange that is disposed in the one space at the attachment completion position and is disposed to face an annular flat surface on the one space side in the annular peripheral edge portion with a gap therebetween coaxially, and a tubular body that is formed by combining the respective divided pipes of the plurality of divided base members and draws the wiring member of the inner insertion path from an opening to the one space, the grommet main body includes an annular waterproof member that is made of an elastically deformable synthetic resin material softer than the base member, is disposed coaxially between the flange and the annular flat surface of the peripheral edge portion at the attachment completion position, and is brought into close contact with the annular flat surface over an entire periphery, the tubular body includes a bent portion that coaxially protrudes from the flange and is bent at a tip thereof, and a straight pipe portion provided with the opening, and the opening is closed by a waterproof tape wound between an outer peripheral surface of the straight pipe portion and the wiring member drawn out from the opening, and the straight pipe portion is provided with a tape position designation portion which designates an allowable range of an end portion position of the waterproof tape on the straight pipe portion side at a place where the seal member is disposed on the outer peripheral surface and between the inner joint surfaces.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a grommet according to an embodiment before being attached to an insertion object;

FIG. 2 is a plan view of the grommet according to the embodiment as viewed from the side;

FIG. 3 is a perspective view of the grommet according to the embodiment as viewed from another angle;

FIG. 4 is an exploded perspective view illustrating the grommet of the embodiment;

FIG. 5 is an exploded perspective view of a divided base member and a seal member of the embodiment;

FIG. 6 is a perspective view for describing winding of the waterproof tape;

FIG. 7 is a plan view for describing winding of the waterproof tape; and

FIG. 8 is a plan view for describing a definition of a first end portion of a tape position designation portion.

### DETAILED DESCRIPTION OF THE PREFERRED EMBODIMENTS

Hereinafter, embodiments of a grommet according to the present invention will be described in detail with reference to the drawings. Note that the present invention is not limited by the embodiment.

### Embodiment

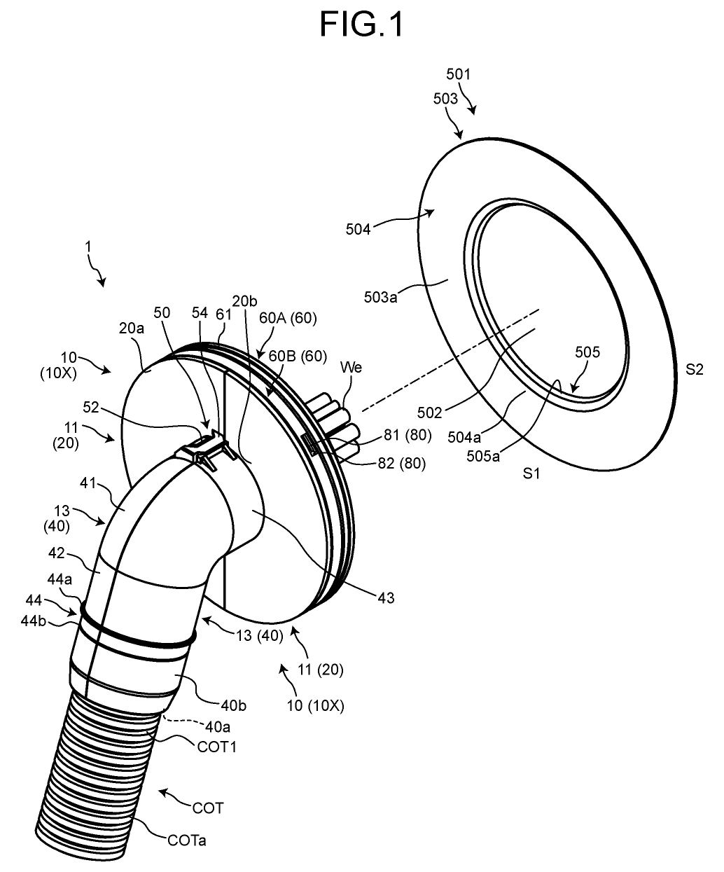

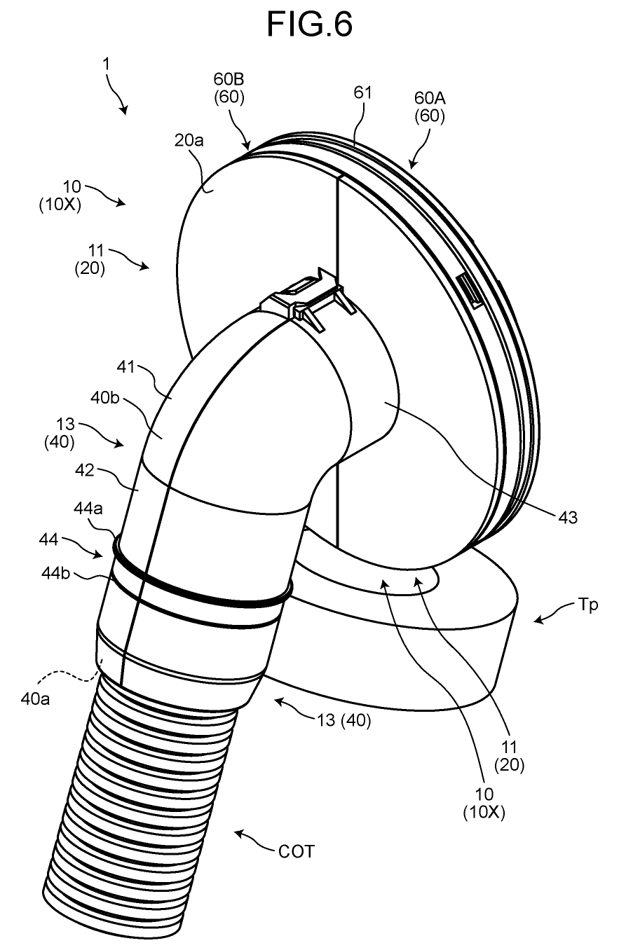

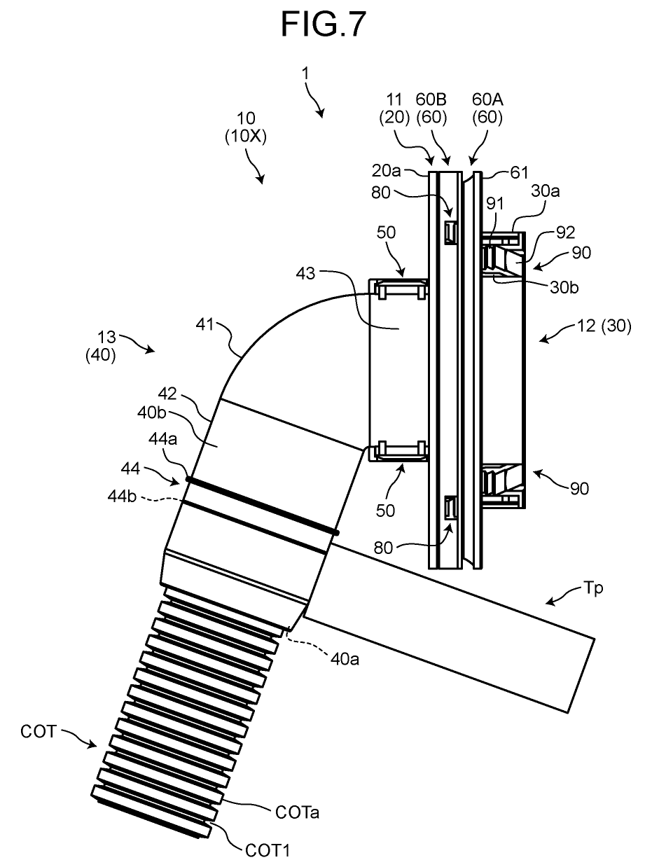

One embodiment of a grommet according to the present invention will be described with reference to FIGS. 1 to 8.

Reference numeral 1 in FIGS. 1 to 4 denotes a grommet according to the present embodiment. The grommet 1 protects a conductive wiring member We passing through a through-hole 502 of an insertion object 501 between one space S1 and the other space S2 from a peripheral edge portion 503 of the through-hole 502 in the insertion object 501, and prevents liquid (water or the like) from entering into the gap between the annular peripheral edge portion 503 and the wiring member We (FIG. 1). Therefore, the grommet 1 is attached to the peripheral edge portion 503 of the through-hole 502 of the insertion object 501 after the wiring member We is inserted.

Here, the wiring member We is, for example, an electric wire (electric wire as communication wire, electric wire as power supply wire, and the like). In addition, the insertion object 501 is a member for inserting the wiring member We, and indicates, for example, a wall body such as a panel of a vehicle body in the case of a vehicle. The wiring member We is routed between one space S1 and the other space S2 separated by the insertion object 501 by being inserted into the through-hole 502 of the insertion object 501. For example, the wiring member We is responsible for communication between devices in one space S1 and the other space S2, or is responsible for supplying power from a power source of the other space S2 to an electric device in the one space S1.

The peripheral edge portion 503 of the through-hole 502 of the insertion object 501 includes an annular flat plate portion (hereinafter referred to as an "annular flat plate portion") 504, and an annular projection portion (hereinafter referred to as an "annular projection portion") 505 protruding from an end portion of an inner peripheral edge of the annular flat plate portion 504 (inner peripheral edge portion 504a) toward the other space S2 (FIG. 1). The grommet 1 is attached to the annular flat plate portion 504 and the annular projection portion 505 at the peripheral edge portion 503. For example, the insertion object 501 is formed by press molding, and the annular flat plate portion 504 and the through-hole 502 are formed at that time. In the insertion object 501, the annular projection portion 505 is formed by burring the peripheral edge of the through-hole 502. Here, since the through-hole 502 is formed in a circular shape, the annular flat plate portion 504 and the annular projection portion 505 are each formed in an annular shape.

The grommet 1 includes a base member 10X through which the wiring member We is inserted into the inner insertion path (FIGS. 1 to 8). The base member 10X includes a plurality of divided base members radially divided around the axis of the insertion path, and is formed by assembling the plurality of divided base members to each other. In the base member 10X, an insertion path is formed on the inside by aligning and joining the joint surfaces of the plurality of divided base members facing each other. The plurality of divided base members may be members having different shapes, or may be the same members having the same shape. In the present embodiment, the base member 10X is constituted by two divided base members: a first divided base member and a second divided base member. Here, the same members (divided base members 10 and 10) having the same shape are used for the two divided base members (FIGS. 1 to 8).

The base member 10X includes an annular flange 20, a cylindrical body 30, and a tubular body 40 coaxially, and the wiring member We is inserted into these members (FIGS. 1 to 8). Here, on the same axis, the cylindrical body 30 protrudes from the flange 20 toward one side, and the tubular body 40 protrudes from the flange 20 toward the other side.

In the base member 10X illustrated here, as will be described later, the annular flange 20, the cylindrical body 30, and the tubular body 40 are coaxially formed by the divided base members 10 and 10 assembled to each other. Therefore, a holding mechanism (hereinafter referred to as a "base holding mechanism") 50 for holding the two divided base members 10 and 10 adjacent to each other around the axis of the insertion path in an assembled state is provided between the two divided base members 10 and 10 (FIGS. 1 to 3).

In addition, the grommet 1 includes an annular grommet main body 60 assembled to the base member 10X (divided base members 10 and 10 assembled to each other) (FIGS. 1 to 4 and FIGS. 6 to 8). The grommet main body 60 is disposed in the one space S1 at the attachment completion position of the grommet 1 to the peripheral edge portion 503 in order to prevent liquid (water or the like) from entering the other space S2 from the one space S1 through the through-hole 502. In the following description, when simply described as the "attachment completion position", the position indicates the attachment completion position of the grommet 1 with respect to the peripheral edge portion 503.

The base member 10X (divided base members 10 and 10) is molded using an insulating hard synthetic resin material (hereinafter referred to as a "hard resin"). Here, for example, the base member 10X (divided base members 10 and 10) is molded using a hard resin such as plastic.

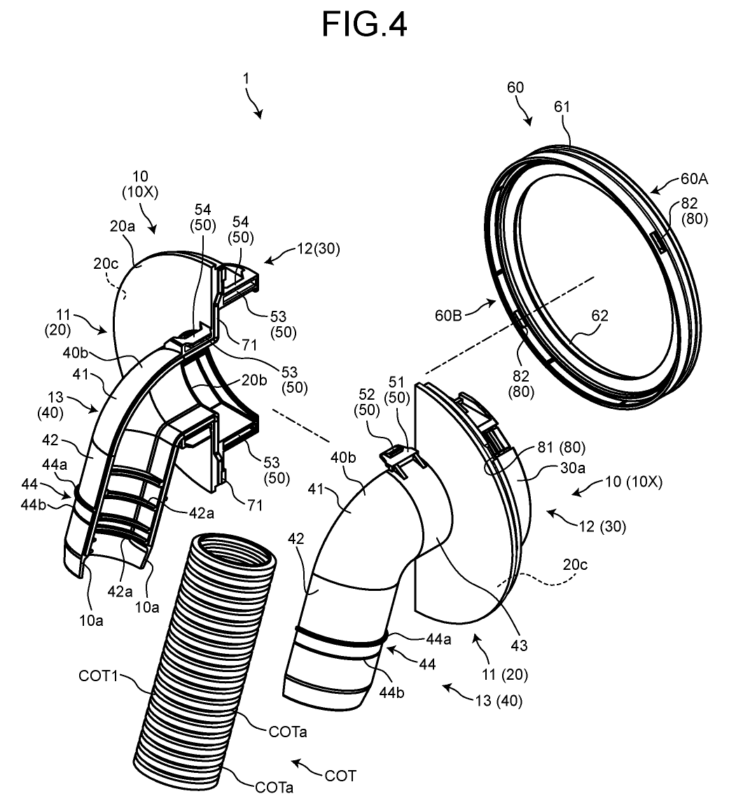

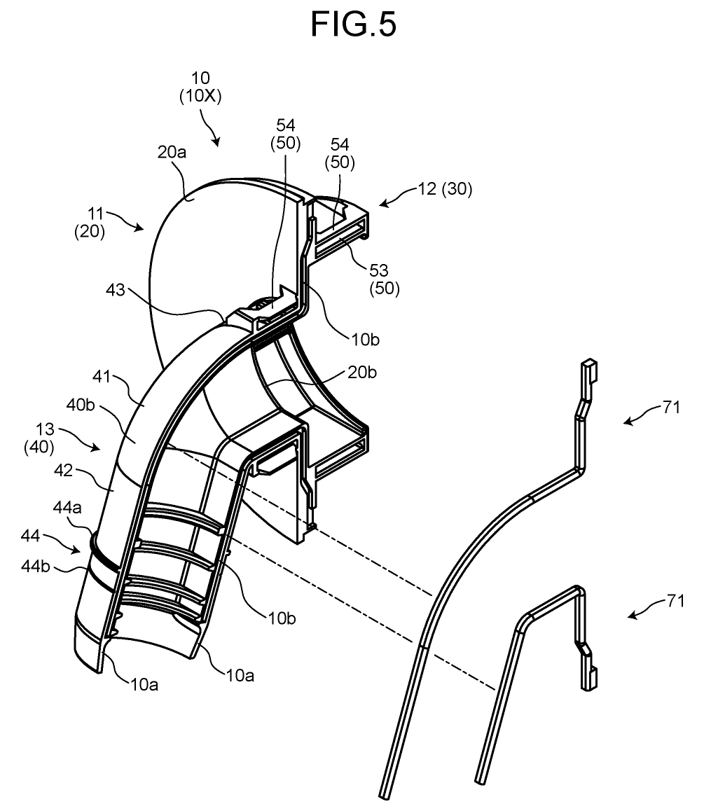

The two divided base members 10 and 10 are assembled by aligning and joining a joint surfaces 10a thereof (FIGS. 4 and 5). The two divided base members 10 and 10 sandwich the wiring member We in the assembled state, and insert the wiring member We into the inner insertion path. Here, the annular flange 20, the cylinder-like cylindrical body 30, and the tube-like tubular body 40 are formed by assembling the two divided base members 10 and 10.

The flange 20 is disposed in the one space S1 at the attachment completion position, and is disposed to face an annular flat surface 503a (FIG. 1) on the one space S1 side in the peripheral edge portion 503 coaxially with a gap. The annular flat surface 503a is provided on the annular flat plate portion 504. The annular flat surface 503a illustrated here is the annular flat surface itself on the one space S1 side of the annular flat plate portion 504. The flange 20 is disposed such that an annular outer peripheral edge portion (hereinafter referred to as a "flange outer peripheral edge portion") 20a side faces the annular flat surface 503a coaxially with a gap in the hole axial direction of the through-hole 502 at the attachment completion position. Then, the flange 20 has the wiring member We inserted into an annular inner peripheral edge portion (hereinafter referred to as a "flange inner peripheral edge portion") 20b.

The flange 20 is formed in a plate shape. Therefore, an annular wall surface (hereinafter referred to as a "flange surface") 20c is provided on the flange outer peripheral edge portion 20a side of the flange 20 to be disposed to face the annular flat surface 503a coaxially with the annular flat surface at the attachment completion position with a gap therebetween (FIG. 4). Here, the flange 20 is formed in an annular shape.

The flange 20 is formed by combining divided flanges 11 of each of the plurality of divided base members 10 (FIGS. 1 to 8). Here, a flange 20 is formed from each of the divided flanges 11 by aligning and joining the joint surfaces 10a of the two divided base members 10 and 10. The divided flange 11 illustrated here is obtained by dividing the flange 20 in half along the central axis, and is formed in a semicircular arc shape.

The cylindrical body 30 protrudes coaxially from the flange 20 toward the other space S2 and is inserted into the through-hole 502 at the attachment completion position. That is, in the cylindrical body 30, the distal end of the tip protruding from the flange 20 is disposed in the other space S2. The cylindrical body 30 is formed in a cylindrical shape. The cylindrical body 30 protrudes from between the flange outer peripheral edge portion 20a and the flange inner peripheral edge portion 20b of the flange 20, and the wiring member We is inserted into the cylindrical body (FIG. 4). Here, for example, the flange 20 is divided into two: the flange outer peripheral edge portion 20a side and the flange inner peripheral edge portion 20b side in the radial direction, and the cylindrical body 30 protrudes from a boundary part between the flange outer peripheral edge portion 20a side and the flange inner peripheral edge portion 20b side.

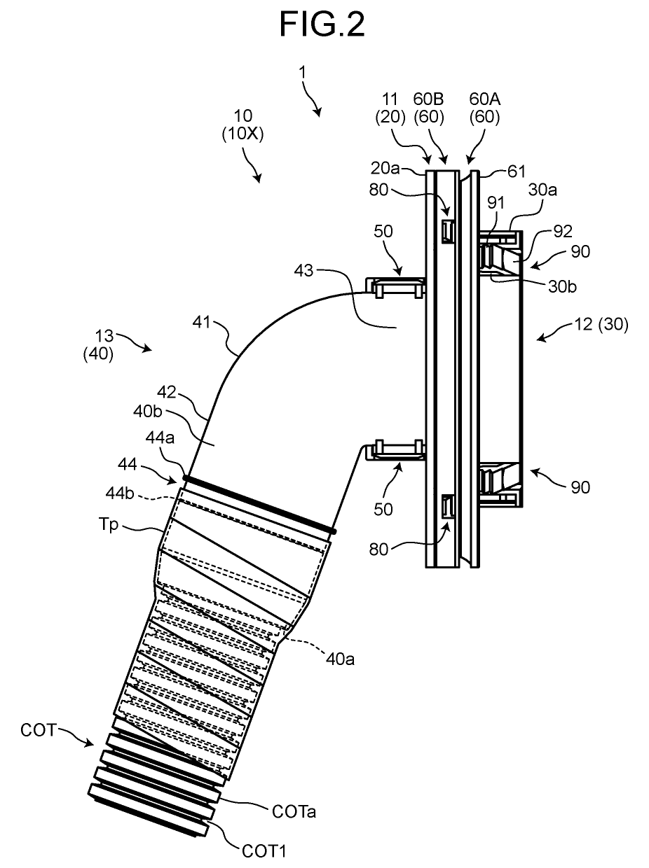

The cylindrical body 30 is formed by combining divided cylinders 12 of each of the plurality of divided base members 10 (FIGS. 2 to 8). Here, the cylindrical body 30 is formed from each of the divided cylinders 12 by aligning and joining the joint surfaces 10a of each of the two divided base members 10 and 10. The divided cylinder 12 illustrated here is obtained by dividing the cylindrical body 30 in half along the central axis, and is formed in a semicircular arc shape.

The tubular body 40 protrudes coaxially from the flange 20 in the direction opposite to the cylindrical body 30, and the wiring member We of the inner insertion path is drawn out from an opening 40a (FIGS. 1 to 3 and FIGS. 6 to 8) to one space S1. The tubular body 40 is formed in a tubular shape. The tubular body 40 illustrated here protrudes from the flange inner peripheral edge portion 20b of the flange 20, and the wiring member We is inserted into an insertion path in the tubular body 40 (FIGS. 1 and 3 to 5).

The tubular body 40 has a bent portion 41 that protrudes coaxially from the flange 20 and is bent at the tip thereof (FIGS. 1 to 8). In the tubular body 40, the bent portion 41 may be provided at one location, or the bent portion 41 may be provided at a plurality of locations. In addition, the tubular body 40 has a straight pipe portion 42 provided with the opening 40a (FIGS. 1 to 8). The tubular body 40 illustrated here is bent immediately after coaxially protruding from the flange 20, and an opening 40a is provided in the straight pipe portion 42 at the tip of the bending. That is, the tubular body 40 illustrated here includes a straight pipe portion (hereinafter referred to as a "root side straight pipe portion") 43 on the root side coaxially protruding from the flange 20, a straight pipe portion (hereinafter referred to as a "distal end side straight pipe portion") 42 on the distal end side provided with the opening 40a, and one bent portion 41 sandwiched between the root side straight pipe portion 43 and the distal end side straight pipe portion 42 (FIGS. 1 to 8).

The tubular body 40 is formed by combining divided pipes 13 of each of the plurality of divided base members 10 (FIGS. 1 to 8). Here, the tubular body 40 is formed from each of the divided pipes 13 by aligning and joining the respective joint surfaces 10a of the two divided base members 10 and 10. The divided pipe 13 illustrated here is obtained by dividing the tubular body 40 in half along the central axis, and is formed in a semicircular arc shape.

As described above, the divided base member 10 has high hardness such that the main body part (divided flange 11, divided cylinder 12, divided pipe 13) is hardly elastically deformed. For this reason, in the divided base member 10, for example, a fine gap due to the surface roughness or the like of the joint surface 10a may be formed between the joint surfaces 10a of the mating divided base member 10. Therefore, the grommet 1 of the present embodiment includes a seal member 71 that is sandwiched between the joint surfaces 10a facing each other of the plurality of divided base members 10 and fills the gap between the joint surfaces 10a at the sandwiching position (FIGS. 4 and 5).

The seal member 71 is made of a synthetic resin material (hereinafter referred to as a "soft resin") softer than the hard resin of the divided base member 10 and elastically deformable, and is provided on at least one of the joint surfaces 10a facing each other. The seal member 71 is molded using, for example, a synthetic resin material such as an elastomer. The seal member 71 is provided, for example, over the respective joint surfaces 10a of the divided flange 11, the divided cylinder 12, and the divided pipe 13. In the divided base member 10 illustrated here, groove portions 10b are formed on the joint surfaces 10a at two positions from the divided flange 11 to the divided pipe 13, and the seal member 71 is fitted into the respective groove portions 10b (FIG. 5). The seal member 71 protrudes from the groove portion 10b. For example, the seal member 71 is produced by two-color molding with the divided base member 10, or is insert-molded with respect to the divided base member 10 housed in a mold, and is integrally molded with respect to the divided base member 10. Further, the seal member 71 may be molded as a part different from the divided base member 10, and may be attached to the groove portion 10b of the divided base member 10 with an adhesive or the like. In the base member 10X, by assembling the two divided base members 10 and 10, the seal member 71 protruding from the groove portion 10b of the respective joint surface 10a of one divided base member 10 is brought into close contact with the respective joint surfaces 10a of the other divided base member 10.

The base holding mechanism 50 is a holding mechanism for holding the two divided base members 10 and 10 in a state where the respective joint surfaces 10a are aligned and joined. The base holding mechanism 50 illustrated here is provided at a plurality of locations between the two divided base members 10 and 10. For example, the base holding mechanism 50 illustrated here includes a piece portion 51 protruding from one joint surface 10a of the two divided base members 10 and 10, and a claw-like first locking portion 52 protruding from a wall surface of the piece portion 51 (FIG. 4). The base holding mechanism 50 illustrated here includes: an insertion port 53 which is provided on the other joint surface 10a in the two divided base members 10 and 10, and into which the one piece portion 51 and the first locking portion 52 are inserted; and a second locking portion 54 provided on the other of the two divided base members 10 and 10 and disposed to face the first locking portion 52 when the respective joint surfaces 10a thereof are aligned and joined to hold the two divided base members 10 and 10 in a state where the respective joint surfaces 10a are aligned and joined (FIG. 4). The second locking portion 54 is pushed and bent by the first locking portion 52 inserted from the insertion port 53, and has flexibility such that the first locking portion 52 is separated to eliminate the bending when the joint surfaces 10a are joined to each other.

Each of the two divided base members 10 and 10 illustrated here includes: a set of piece portions 51 and the first locking portion 52 at one end in the peripheral direction of the divided cylinder 12; and a set of insertion ports 53 and the second locking portion 54 at the other end in the peripheral direction of the divided cylinder 12. In the two divided base members 10 and 10, the first locking portion 52 at one end of the one divided cylinder 12 and the second locking portion 54 at the other end of the other divided cylinder 12 are locked, and the second locking portion 54 at the other end of the one divided cylinder 12 and the first locking portion 52 at one end of the other divided cylinder 12 are locked in a state where the respective joint surfaces 10a are aligned and joined. That is, in the two divided base members 10 and 10, the base holding mechanisms 50 that connect the respective divided cylinders 12 and hold the divided cylinders 12 in a connected state are provided at two locations. Each of the two divided base members 10 and 10 includes: a set of piece portions 51 and the first locking portion 52 at one end in the peripheral direction of the divided pipe 13; and a set of insertion ports 53 and the second locking portion 54 at the other end in the peripheral direction of the divided pipe 13. In the two divided base members 10 and 10, the first locking portion 52 at one end of the one divided pipe 13 and the second locking portion 54 at the other end of the other divided pipe 13 are locked, and the second locking portion 54 at the other end of the one divided pipe 13 and the first locking portion 52 at one end of the other divided pipe 13 are locked in a state where the respective joint surfaces 10a are aligned and joined. That is, in the two divided base members 10 and 10, the base holding mechanisms 50 that connect the respective divided pipes 13 and hold the divided pipes 13 in a connected state are provided at two locations. Here, the base holding mechanisms 50 at two locations are provided in the root side straight pipe portion 43 of the tubular body 40.

In the base member 10X (divided base members 10 and 10 assembled to each other), the wiring member We is drawn out from the opening 40a of the tubular body 40 to one space S1, and the wiring member We is drawn out from the opening of the cylindrical body 30 to the other space S2. In the grommet 1, a gap between the flange 20 of the base member 10X (divided base members 10 and 10 assembled to each other) and the annular flat surface 503a of the peripheral edge portion 503 is closed by the grommet main body 60 to prevent liquid (water or the like) from entering from one space S1 to the other space S2 through the through-hole 502. In the grommet 1, the opening 40a of the tubular body 40 is closed with a waterproof tape Tp to prevent liquid (water or the like) from entering the opening 40a into the insertion path inside the tubular body 40 (FIGS. 2 and 6 to 8).

The grommet main body 60 includes: an annular waterproof member 60A made of a soft resin (that is, an elastically deformable synthetic resin material softer than the hard resin of the base member 10X (divided base member 10)); and an annular support member 60B made of a synthetic resin material harder than the soft resin of the waterproof member 60A and integrated with the waterproof member 60A (FIGS. 1 to 4 and FIGS. 6 to 8). The waterproof member 60A is molded using, for example, a synthetic resin material such as an elastically deformable elastomer softer than the hard resin of the base member 10X (divided base member 10) and the support member 60B. Further, the support member 60B is made of, for example, the same hard resin as the base member 10X (divided base member 10) or a hard resin different from the hard resin having hardness equivalent to that of the hard resin of the base member 10X (divided base member 10), and is molded using a synthetic resin material such as plastic.

The grommet main body 60 is configured as a molded article in which the waterproof member 60A and the support member 60B are integrally molded. In the grommet main body 60, the waterproof member 60A is integrated with the support member 60B. For example, the waterproof member 60A is produced by two-color molding with the support member 60B in the mold, or is insert-molded with respect to the support member 60B housed in a mold, and is integrally molded with the support member 60B. In addition, the waterproof member 60A may be molded as a part different from the support member 60B and attached to the support member 60B with an adhesive or the like.

The grommet main body 60 is assembled to the base member 10X (divided base members 10 and 10 assembled to each other) through the support member 60B.

The waterproof member 60A is coaxially brought into close contact with the flange 20 at an assembly completion position with the base member 10X (divided base members 10 and 10 assembled to each other), is coaxially disposed between the flange 20 and the annular flat surface 503a of the peripheral edge portion 503 at an attachment completion position, and is brought into close contact with the annular flat surface 503a over an entire periphery. The waterproof member 60A has, for example, an annular lip that is elastically deformed at the assembly completion position and comes into close contact with the flange surface 20c of the flange 20 coaxially over the entire periphery (not illustrated). In addition, the waterproof member 60A has an annular outer peripheral lip 61 and an annular inner peripheral lip 62 that are elastically deformed at the attachment completion position and comes into close contact with the annular flat surface 503a of the peripheral edge portion 503 coaxially over the entire periphery (FIGS. 1 to 4). Furthermore, in the following, when simply described as the "assembly completion position", it indicates the assembly completion position of the base member 10X (divided base members 10 and 10 assembled to each other) and the grommet main body 60.

The support member 60B is molded as an annular member integrated with the outer peripheral edge portion of the waterproof member 60A and coaxially protruding from the outer peripheral edge portion toward the flange outer peripheral edge portion 20a of the flange 20 (FIGS. 1 to 4 and FIGS. 6 to 8). The support member 60B is molded in an annular shape.

An engagement mechanism 80 is provided between the base member 10X (the divided base members 10 and 10 assembled to each other) and the support member 60B, which engages a first engagement portion 81 provided on the base member 10X (divided base members 10 and 10 assembled to each other) with a second engagement portion 82 provided on the support member 60B, thereby holding the base member 10X (divided base members 10 and 10 assembled to each other) and the grommet main body 60 at the assembly completion position (FIGS. 1 to 4). The first engagement portion 81 is formed as a claw-like projection portion protruding outward in the radial direction from the flange outer peripheral edge portion 20a of the flange 20. In addition, the second engagement portion 82 is a through-hole formed in the support member 60B, and the first engagement portion 81 is inserted and locked to the inner peripheral wall surface thereof at the assembly completion position. A plurality of the engagement mechanisms 80 are provided around the axis of the cylinder axis of the base member 10X (divided base members 10 and 10 assembled to each other). Here, four engagement mechanisms 80 are provided at equal intervals around the axis of the cylinder axis of the base member 10X, two of them are provided in the divided flange 11 of one divided base member 10, and the remaining two are provided in the divided flange 11 of the other divided base member 10.

The waterproof tape Tp is wound around the axis of an outer peripheral surface 40b of the tubular body 40 (FIGS. 2 and 6 to 8). The opening 40a of the tubular body 40 is closed by the waterproof tape Tp wound between the outer peripheral surface 40b of the distal end side straight pipe portion 42 and the wiring member We drawn out from the opening 40a.

A wire harness WH of the present embodiment includes a plurality of wiring members We, and all or at least a part of the plurality of wiring members We excluding both ends is bundled together by an exterior component such as a corrugated tube or a resin tape. The plurality of wiring members We illustrated here are covered with a corrugated tube COT (FIGS. 1 to 4 and FIGS. 6 to 8) in the tube of the distal end side straight pipe portion 42, and are drawn out from the opening 40a together with the corrugated tube COT. Therefore, the waterproof tape Tp of this example is wound between the outer peripheral surface 40b of the distal end side straight pipe portion 42 and an outer peripheral surface COTa of the corrugated tube COT as the exterior component drawn out from the opening 40a (FIGS. 2 and 6 to 8).

Furthermore, the distal end side straight pipe portion 42 has an annular protrusion portion 42a that protrudes annularly from the inner peripheral surface thereof over one periphery in the peripheral direction and is fitted into an annular valley portion COT1 of the corrugated tube COT in the pipe (FIG. 4). The distal end side straight pipe portion 42 has a plurality of annular protrusion portions 42a coaxially spaced, and the corrugated tube COT in the pipe is held by the plurality of protrusion portions 42a.

Here, the groove portion 10b of the joint surface 10a of the divided pipe 13 is formed up to the front of the opening 40a not to penetrate the end surface on the opening 40a side of the divided pipe 13 in view of waterproofness. Therefore, the seal member 71 is routed from the divided flange 11 to the divided pipe 13 along the joint surface 10a, but stops immediately before the opening 40a. Therefore, in the tubular body 40, a gap is formed between the joint surfaces 10a at the distal end of the distal end side straight pipe portion 42 on the opening 40a side. Therefore, in the distal end side straight pipe portion 42, the waterproof tape Tp is wound up to a place where the seal member 71 is disposed between the inner joint surfaces 10a. Therefore, the distal end side straight pipe portion 42 is provided with a tape position designation portion 44 that designates an allowable range of the end portion position of the waterproof tape Tp on the distal end side straight pipe portion 42 side at a place where the seal member 71 is disposed on the outer peripheral surface 40b between the inner joint surfaces 10a (FIGS. 1 to 8). Accordingly, in the grommet 1 according to the present embodiment, by winding the waterproof tape Tp around the distal end side straight pipe portion 42 up to the tape position designation portion 44 with the tape position designation portion 44 as a mark, the gap between the joint surfaces 10a at the distal end of the distal end side straight pipe portion 42 on the opening 40a side can be closed with the waterproof tape Tp. Therefore, the grommet 1 of the present embodiment can ensure waterproofness by the waterproof tape Tp.

The tape position designation portion 44 includes: a first end portion 44a indicating an allowable limit position on the bent portion 41 side of the end portion position of the waterproof tape Tp; and a second end portion 44b indicating an allowable limit position on the opening 40a side of the end portion position of the waterproof tape Tp (FIGS. 1 to 8). The tape position designation portion 44 indicates an allowable range (an allowable range of the end portion position on the distal end side straight pipe portion 42 side of the waterproof tape Tp) at the first end portion 44a and the second end portion 44b. The seal member 71 is routed between the inner joint surfaces 10a between the first end portion 44a and the second end portion 44b, and is connected from the bent portion 41 side with respect to the first end portion 44a to the opening 40a side with respect to the second end portion 44b. That is, the second end portion 44b is provided closer to the bent portion 41 side than the end portion of the seal member 71 on the opening 40a side. Therefore, in the grommet 1 of the present embodiment, by winding the waterproof tape Tp around the tape position designation portion 44 of the distal end side straight pipe portion 42, the waterproof tape Tp can be wound to cover the seal member 71 (FIGS. 2, 6, and 7).

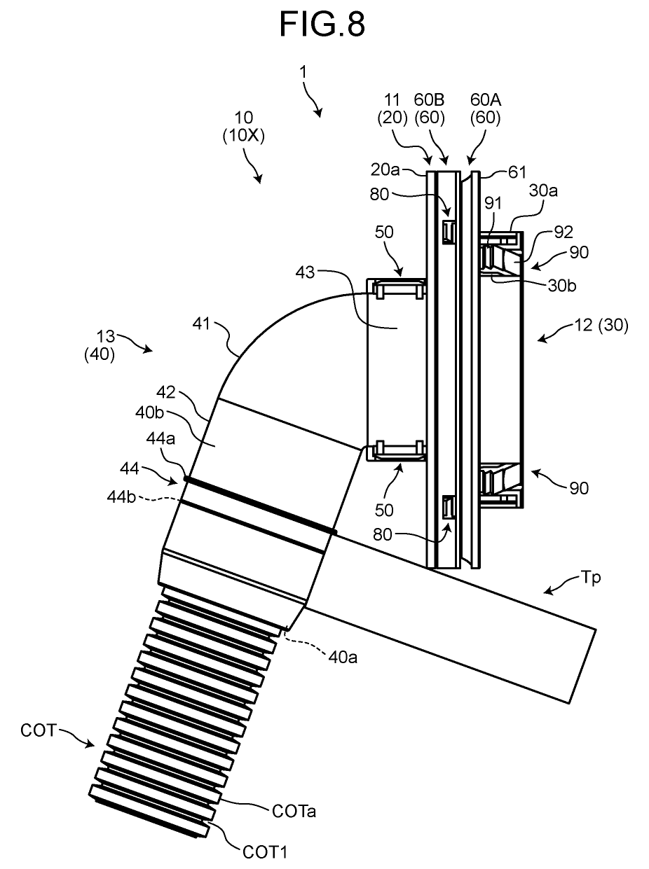

Incidentally, in this grommet 1, a space in which the winding operation of the waterproof tape Tp can be performed is determined depending on the shape of the tubular body 40 such as the bending position and the bending shape and the peripheral shape of the tubular body 40 in the base member 10X (the divided base members 10 and 10 assembled to each other), and thus the position where the waterproof tape Tp can be wound in the distal end side straight pipe portion 42 is limited. In this example, for example, the flange 20 becomes an obstacle to the winding operation of the waterproof tape Tp, and the waterproof tape Tp cannot be wound up to the end portion of the distal end side straight pipe portion 42 on the bent portion 41 side. Therefore, the first end portion 44a is provided at a work limit position where the winding operation of the waterproof tape Tp can be performed on the bent portion 41 side. In this example, the place closest to the bent portion 41 side where the waterproof tape Tp does not collide with the flange 20 when the waterproof tape Tp is wound becomes a work limit position, and the first end portion 44a is provided at this work limit position (FIG. 8). Accordingly, in the grommet 1, the winding operation of the waterproof tape Tp can be facilitated.

For example, the first end portion 44a is formed as an annular projection portion protruding from the outer peripheral surface 40b of the distal end side straight pipe portion 42 in the peripheral direction. When the waterproof tape Tp is wound around the first end portion 44a, the waterproof tape Tp floats from the outer peripheral surface 40b around the first end portion 44a, and a gap may be generated between the waterproof tape Tp and the outer peripheral surface 40b. Therefore, in the grommet 1, by winding the waterproof tape Tp with the second end portion 44b side closer to the first end portion 44a as the end portion position, the waterproof tape Tp at the end portion position can be brought into close contact with the outer peripheral surface 40b, and thus the waterproofness by the waterproof tape Tp can be ensured.

Further, for example, the second end portion 44b is formed as an annular groove portion in which the outer peripheral surface 40b of the distal end side straight pipe portion 42 is recessed in the peripheral direction. As a result, in the grommet 1, the waterproof tape Tp is wound around from above the second end portion 44b, but the waterproof tape Tp can be brought into close contact with the outer peripheral surface 40b even around the second end portion 44b, and thus the waterproofness by the waterproof tape Tp can be ensured.

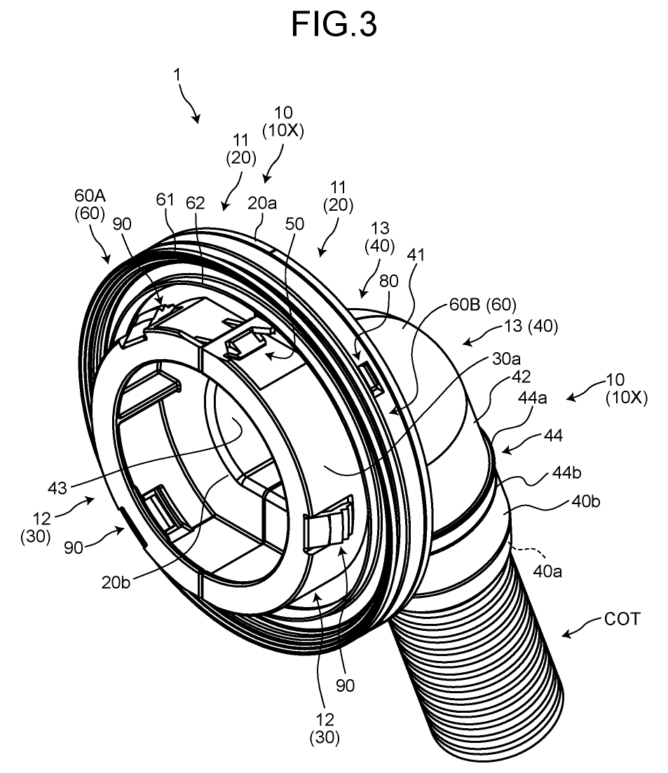

The grommet 1 configured as described above includes the holding mechanism 90 for holding the base members 10X assembled to each other (divided base members 10 and 10 assembled to each other) and the grommet main body 60 in the peripheral edge portion 503 of the through-hole 502 in the insertion object 501 (FIGS. 2 and 3). The holding mechanism 90 illustrated here uses a resilient force accompanying elastic deformation of the outer peripheral lip 61 and the inner peripheral lip 62 of the waterproof member 60A, and sandwiches the peripheral edge portion 503 between the outer peripheral lip 61 and the inner peripheral lip 62 and a following locking portion 91 provided on the base member 10X (base member 10), and holds the grommet 1 in the peripheral edge portion 503.

The base member 10X has the locking portion 91 that protrudes from an outer peripheral surface 30a of the cylindrical body 30 in the other space S2 at the attachment completion position and is brought into contact with the peripheral edge portion 503 from the other space S2 side in the other space S2 at the attachment completion position (FIGS. 2 and 3). The locking portion 91 locks a part of the peripheral edge portion 503 in the peripheral direction. Therefore, the base member 10X has a plurality of the locking portions 91 in the peripheral direction of the cylindrical body 30.

In addition, the base member 10X has a cantilever locking piece portion 92 provided with the locking portion 91 at the free end in the other space S2 at the attachment completion position for each locking portion 91 (FIGS. 2 and 3). The locking piece portion 92 protrudes from the fixed end on the outer peripheral surface 30a side of the cylindrical body 30 to the one space S1 side in the other space S2 at the attachment completion position as a free end, and protrudes from the outer peripheral surface 30a of the cylindrical body 30 on the free end side (initial shape). The locking piece portion 92 is formed to have flexibility capable of being flexurally deformed to change the amount of protrusion from the outer peripheral surface 30a on the free end side. The locking piece portion 92 moves back and forth in a cutout portion 30b obtained by cutting out a part of the cylindrical body 30 due to the bending deformation (FIGS. 2 and 3). A plurality of combinations of the locking portion 91, the locking piece portion 92, and the cutout portion 30b are provided at equal intervals in the peripheral direction with respect to the cylindrical body 30. In the cylindrical body 30 illustrated here, three sets of combinations of the locking portion 91, the locking piece portion 92, and the cutout portion 30b are provided at equal intervals in the peripheral direction.

When the cylindrical body 30 is inserted into the through-hole 502 from the one space S1, the locking piece portion 92 receives a force from the annular projection portion 505 of the peripheral edge portion 503 and is bent and deformed from the initial shape to the cutout portion 30b side, passes through the position of the annular projection portion 505 and goes to the distal end (hereinafter referred to as a "locking end portion") 505a (FIG. 1) of the annular projection portion 505, and returns to the initial shape as the force received from the annular projection portion 505 disappears. Therefore, the locking piece portion 92 is disposed at the tip of the locking end portion 505a of the annular projection portion 505 together with the locking portion 91. Meanwhile, in the waterproof member 60A, when a series of movements of the locking portion 91 and the locking piece portion 92 occurs, the outer peripheral lip 61 and the inner peripheral lip 62 come into contact with the annular flat surface 503a of the peripheral edge portion 503 and elastically deform. Therefore, when the force (so-called insertion force) for inserting the grommet 1 into the through-hole 502 is released, the grommet 1 moves back to the one space S1 side by the resilient force accompanying the elastic deformation of the outer peripheral lip 61 and the inner peripheral lip 62. Accordingly, the locking portion 91 comes into contact with the locking end portion 505a of the annular projection portion 505 and is locked by the locking end portion 505a. That is, the annular projection portion 505 locks the locking portion 91 at the distal end (locking end portion 505a) at the tip protruding from the annular flat plate portion 504. At the annular locking end portion 505a, the locking portion 91 is locked at each place in the peripheral direction. Therefore, the peripheral edge portion 503 is sandwiched between the outer peripheral lip 61 and the inner peripheral lip 62 of the waterproof member 60A and the respective locking portions 91 of the base member 10X (divided base members 10 and 10).

In the grommet according to the present embodiment, by winding the waterproof tape around the straight pipe portion up to the tape position designation portion with the tape position designation portion as a mark, the gap between the joint surfaces at the distal end of the straight pipe portion on the opening side can be closed with the waterproof tape. Therefore, the grommet can ensure waterproofness by the waterproof tape.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A grommet comprising:
a base member including a plurality of divided base members made of a synthetic resin material radially divided around an axis of an insertion path, in which a conductive wiring member passed through a through-hole of an insertion object between one space and the other space is inserted into the inner insertion path formed by aligning and joining joint surfaces of the plurality of divided base members facing each other;
an annular grommet main body assembled to the base member and disposed in the one space at an attachment completion position of the insertion object to a peripheral edge portion of the through-hole; and
a seal member sandwiched between the joint surfaces facing each other of the plurality of divided base members and filling a gap between the joint surfaces at a sandwiching position, wherein
the base member includes an annular flange that is disposed in the one space at the attachment completion position and is disposed to face an annular flat surface on the one space side in the annular peripheral edge portion with a gap therebetween coaxially, and a tubular body that is formed by combining the respective divided pipes of the plurality of divided base members and draws the wiring member of the inner insertion path from an opening to the one space,
the grommet main body includes an annular waterproof member that is made of an elastically deformable synthetic resin material softer than the base member, is disposed coaxially between the flange and the annular flat surface of the peripheral edge portion at the attachment completion position, and is brought into close contact with the annular flat surface over an entire periphery,
the tubular body includes a bent portion that coaxially protrudes from the flange and is bent at a tip thereof, and a straight pipe portion provided with the opening, and the opening is closed by a waterproof tape wound between an outer peripheral surface of the straight pipe portion and the wiring member drawn out from the opening, and
the straight pipe portion is provided with a tape position designation portion which designates an allowable range of an end portion position of the waterproof tape on the straight pipe portion side at a place where the seal member is disposed on the outer peripheral surface and between the inner joint surfaces.

2. The grommet according to claim 1, wherein
the tape position designation portion has a first end portion indicating an allowable limit position on the bent portion side of the end portion position of the waterproof tape and a second end portion indicating an allowable limit position on the opening side of the end portion position of the waterproof tape, and the allowable range is indicated by the first end portion and the second end portion.

3. The grommet according to claim 1, wherein
the tape position designation portion has a first end portion indicating an allowable limit position on the bent portion side of the end portion position of the waterproof tape and a second end portion indicating an allowable limit position on the opening side of the end portion position of the waterproof tape, and indicates the allowable range by the first end portion and the second end portion,
the first end portion is an annular projection portion protruding from the outer peripheral surface of the straight pipe portion in a peripheral direction, and
the second end portion is an annular groove portion in which the outer peripheral surface of the straight pipe portion is recessed in the peripheral direction.

4. The grommet according to claim 2, wherein
the first end portion is provided at a work limit position where a winding operation of the waterproof tape is possible on the bent portion side, and
the second end portion is provided closer to the bent portion side than an end portion of the seal member on the opening side.

5. The grommet according to claim 3, wherein
the first end portion is provided at a work limit position where a winding operation of the waterproof tape is possible on the bent portion side, and
the second end portion is provided closer to the bent portion side than an end portion of the seal member on the opening side.

6. The grommet according to claim 1, wherein
the plurality of wiring members are covered with an exterior component in a pipe of the straight pipe portion, and are drawn out from the opening together with the exterior component, and
the waterproof tape is wound between the outer peripheral surface of the straight pipe portion and an outer peripheral surface of the exterior component drawn out from the opening.

7. The grommet according to claim 2, wherein
the plurality of wiring members are covered with an exterior component in a pipe of the straight pipe portion, and are drawn out from the opening together with the exterior component, and
the waterproof tape is wound between the outer peripheral surface of the straight pipe portion and an outer peripheral surface of the exterior component drawn out from the opening.

8. The grommet according to claim 3, wherein
the plurality of wiring members are covered with an exterior component in a pipe of the straight pipe portion, and are drawn out from the opening together with the exterior component, and
the waterproof tape is wound between the outer peripheral surface of the straight pipe portion and an outer peripheral surface of the exterior component drawn out from the opening.
